(19) United States
(12) Patent Application Publication
(10) Pub. No.: US 2026/0021798 A1
(43) Pub. Date: Jan. 22, 2026

(54) THREADED DRIVE FOR AN ELECTROMECHANICAL BRAKE AND BRAKE ACTUATOR OF AN ELECTROMECHANICAL VEHICLE BRAKE AND ELECTROMECHANICAL BRAKE

(71) Applicant: ZF Active Safety GmbH, Koblenz (DE)

(72) Inventors: Marco Becker, Oberduerenbach (DE); Michael Weins, Muenstermaifeld (DE); Lukas Madzgalla, Lahnstein (DE); Florian Roessinger, Neuwied (DE)

(21) Appl. No.: 19/272,285

(22) Filed: Jul. 17, 2025

(30) Foreign Application Priority Data
Jul. 18, 2024 (DE) 102024120266.1

(51) Int. Cl. B60T 13/74; F16D 55/226; F16D 65/18; F16D 121/24; F16D 125/40

(52) U.S. Cl. CPC B60T 13/746; F16D 55/226; F16D 65/18; F16D 2121/24; F16D 2125/40

(57) ABSTRACT

A threaded drive (18) for an electromechanical brake is shown, having a pot-shaped spindle nut with a base and a circumferential wall which has a thread (34) on the inside. In addition, the threaded drive (18) comprises a spindle (20) having an external thread, which projects with its external thread into the interior of the spindle nut, and a drive geometry (38) on the spindle (20) for transmitting a rotational movement to the spindle (20), which, via the external thread, moves the spindle nut axially. The spindle (20) has an end face facing the inner side of the base of the spindle nut and with at least one groove in the shape of an annular segment which extends concentrically with a central axis of rotation of the threaded drive (18) and ends in a stop wall. A stop attachment on the base of the spindle nut penetrates, at the end of the axial movement of the spindle nut relative to the spindle (20), the groove and strikes the stop wall. Alternatively, the base of the spindle nut has the groove in the shape of an annular segment, and the end face of the spindle (20) has at least one stop attachment projecting towards the base of the spindle nut.

In addition, a brake actuator and an electromechanical brake having such a threaded drive (18) are shown.

### TECHNICAL FIELD

The invention relates to a threaded drive for an electromechanical brake, in particular a ball-screw drive, having a pot-shaped spindle nut with a base and a circumferential wall which has a thread on the inside. Furthermore, the threaded drive has a spindle having an external thread, which projects with its external thread into the interior of the spindle nut, and a drive geometry on the spindle for transmitting a rotational movement to the spindle which, via the external thread, moves the spindle nut axially. The spindle has an end face facing the inside of the base of the piston nut. Furthermore, the invention relates to a brake actuator and an electromechanical brake having such a threaded drive.

### Background

In a threaded drive, in particular a ball-screw drive, used in brake actuators for electromechanical vehicle brakes, the spindle nut usually forms the brake piston. This means that the spindle nut applies the brake pad to a brake rotor. In order to permit an axial movement of the spindle nut, i.e. the brake piston, along the spindle, the spindle nut is guided so as to be fixed against rotation.

Alternatively, the spindle nut can also be designed separately from the brake piston, the spindle nut bearing on the brake piston and moving the latter in order to apply the brake pad to the brake rotor.

In order to prevent the threaded drive from jamming when the spindle moves against the base of the spindle nut, stops which stop the movement of the spindle nut can be provided. These are usually additional components, which increase the size of the threaded drive and its weight.

Such a jam can be freed only with difficulty because of the high friction between the base of the spindle nut and the end face of the spindle, and can lead to delays in the following braking process.

### SUMMARY

It is thus an object of the invention to provide a threaded drive for an electromechanical brake which can be produced as simply as possible and needs no additional weight nor any increased installation space. Furthermore, it is an object of the invention to provide a brake actuator and an electromechanical brake having such a threaded drive.

According to the invention, this object is achieved by a threaded drive for an electromechanical brake having a pot-shaped spindle nut with a base and a circumferential wall which has a thread on the inside. In addition, the threaded drive comprises a spindle with an external thread, which projects with its external thread into the interior of the spindle nut, and a drive geometry on the spindle for transmitting a rotational movement to the spindle which, via the external thread, moves the spindle nut axially. The spindle has an end face facing the inner side of the base of the spindle nut. The end face has at least one groove which is in the shape of an annular segment, extends concentrically with a central axis of rotation of the threaded drive and circumferentially ends in a stop wall terminating the groove. To this end, the base of the spindle nut has at least one stop attachment which projects towards the end face and, at the end of the axial movement of the spindle nut relative to the spindle, penetrates the groove and strikes the stop wall, so that the movement of the spindle stops.

Alternatively, the base of the spindle nut has at least one groove which is in the shape of an annular segment, extends concentrically with a central axis of rotation of the spindle drive and circumferentially ends in a stop wall terminating the groove. The end face of the spindle has at least one stop attachment which projects towards the base of the spindle nut and, at the end of the axial movement of the spindle nut relative to the spindle, penetrates the groove and strikes the stop wall and stops the movement of the spindle.

In principle, the arrangement of the stop attachment on the base of the spindle nut and the provision of the groove on the end face of the spindle are preferred, since the base of the spindle nut is usually very thin and the groove additionally weakens the base of the spindle nut.

In other words, a stopping mechanism is integrated into the threaded drive, in that a groove having a stop wall is provided in one part of the threaded drive, and a stop attachment is provided in the other part. As a result of using a groove, the stop wall is provided within a component of the threaded drive, so that the dimensions are not increased either in the axial or in the radial direction. Thus, play can therefore be ensured and jamming of the threaded drive prevented without the threaded drive needing more installation space.

The spindle nut can form the brake piston, so that an axial movement of the brake piston can be achieved directly via the spindle and no additional component is needed.

Preferably, the drive geometry is present on a shaft protruding axially from the remainder of the spindle. As a result, the spindle can be actuated electrically either directly or else indirectly via a gear mechanism. The drive geometry can in particular be formed in one piece with the spindle, so that no additional components are needed to drive the spindle.

According to one embodiment, at least two grooves in the shape of an annular segment and at least two stop attachments are provided, wherein each stop attachment is arranged in such a way that it can penetrate only its own groove. As a result, it is possible to ensure that, even in the event of damage to a stop attachment, the rotational movement of the spindle is stopped at the desired time. In addition, as a result of the double safeguard with at least two stopping mechanisms, a distribution of the forces can be implemented, so that the service life of the threaded drive can be prolonged.

Provision can be made for the at least two stop attachments to be offset radially relative to one another.

Alternatively, provision can be made for the at least two stop attachments to adjoin one another in the circumferential direction and to be separated from one another circumferentially by stop walls. The selected arrangement of the at least two stop attachments and, in a corresponding way, of the at least two grooves depends on the geometry of the threaded drive, in particular on the radial dimension of the latter.

According to a preferred embodiment, the at least one groove in the shape of an annular segment is at a distance from the circumference of the end face or the circumferential wall. Accordingly, the stop attachment is guided within the groove until the stop attachment comes into contact with the stop wall. This ensures that the stop wall for the stop attachment does not enlarge the corresponding component along the central axis of rotation.

In order to obtain the groove in the shape of an annular segment, the corresponding threaded drive component can be produced, for example, by cold forming or injection moulding. Alternatively, the shape of an annular segment can also be milled in following fabrication of the threaded drive.

According to one embodiment, the spindle has a cavity starting from the end face, in particular a cylindrical cavity. In this way, the weight of the threaded drive can be reduced.

Preferably, the groove in the shape of an annular segment extends through at least 120°, so that trouble-free penetration of the stop attachment in the groove is ensured. Thus, the stopping mechanism of the threaded drive can be ensured independently of the assembly of the threaded drive without the base of the spindle nut coming into direct axial contact with the end face, and jamming of the threaded drive is effectively prevented.

According to a preferred embodiment, the stop wall merges smoothly into the remainder of the base of the spindle nut. This ensures that no additional installation space along the central axis of rotation is needed by the provision of the stop wall, since the stop wall is located completely in the groove, i.e. the recess, in the base of the spindle nut or the end face.

According to a preferred embodiment, the stop wall has a stop surface in the form of a cylindrical circular-segment surface, and the stop attachment has a complementary mating surface. By means of the complementary surfaces, the best possible transmission of force is ensured, so that non-uniform wear of the stop surfaces does not occur. In addition, it is thus possible to ensure that the stop attachment does not slip on the stop wall.

The threaded drive is preferably a ball-screw drive, with balls between the threads.

According to the invention, the object is additionally achieved by a brake actuator of an electromechanical brake which comprises a brake calliper in which an intermediate space for a brake rotor is formed and, in the intermediate space, has a brake pad which can be applied to the brake rotor. Furthermore, the brake actuator comprises a threaded drive as described above and an electric motor, which is coupled in drive terms to the drive geometry of the spindle. As a result, a rotational movement is transmitted to the spindle, so that the spindle nut can be moved by the rotational movement of the spindle between a retracted and an extended position along the central axis of rotation. In other words, the brake actuator can move the spindle nut via the rotational movement of the spindle into an extended position, in which the brake pad is applied to the brake rotor, or into a retracted position, in which the vehicle brake is released.

Furthermore, according to the invention the object is achieved by an electromechanical brake having a brake calliper in which an intermediate space for a brake rotor is formed and, in the intermediate space, has a brake pad which can be applied to the brake rotor, as well as a brake actuator described previously for moving the brake pad and engaging the brake.

As a result of the use of the threaded drive described previously in the brake actuator and thus in the electromechanical brake, it is ensured that the necessary play in the retracted position, i.e. with the brake released, can be ensured and jamming of the threaded drive does not occur, so that, when the brake is actuated, the extended position, i.e. the engaged position, can be reached at any time.

In order to ensure the movement of the spindle nut, the electromechanical brake preferably has an anti-rotation safeguard which prevents the spindle nut rotating in relation to the central axis of rotation of the threaded drive, so that the rotational movement of the spindle ensures an axial movement of the spindle nut. The rotational locking of the spindle nut can be implemented, for example, by means of a key.

### BRIEF DESCRIPTION OF THE DRAWINGS

Further advantages and features of the invention are gathered from the following description and from the appended drawings to which reference is made. In the drawings:

FIG. 1 shows a perspective partial view of an electromechanical brake according to the invention;

FIG. 2 shows a perspective view of a ball-screw drive according to the invention;

FIG. 3 shows a perspective view of a brake piston of the ball-screw drive shown in FIG. 2; and

FIG. 4 shows a perspective view of a spindle of the ball-screw drive shown in FIG. 2.

### DESCRIPTION

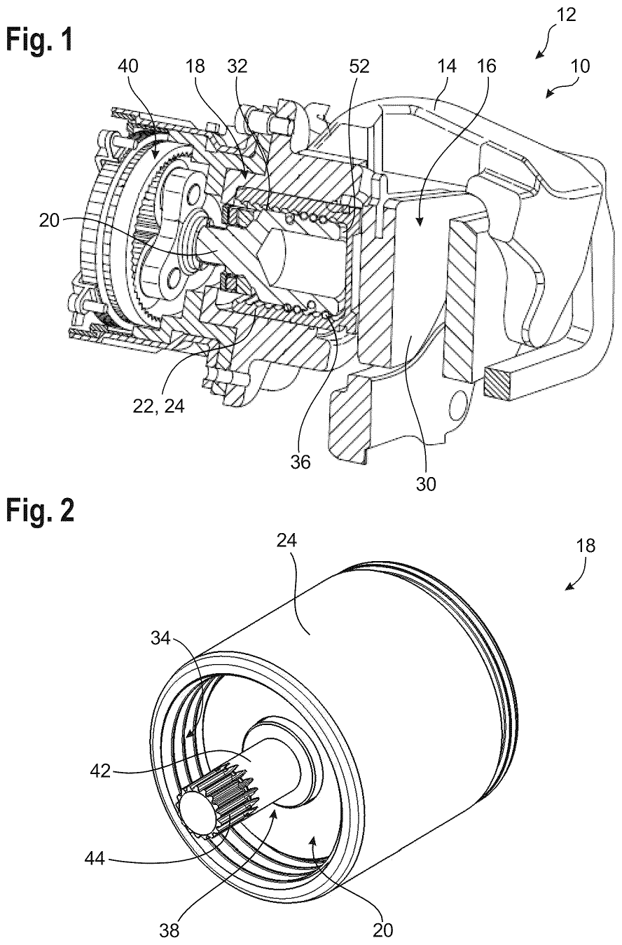

FIG. 1 shows a brake actuator 10 for an electromechanical brake 12 of a vehicle. The electromechanical brake 12 comprises a brake calliper 14, in which an intermediate space 16 for a brake rotor, not shown, is formed. Furthermore, the electromechanical brake 12 comprises a ball-screw drive 18 with a rotatably mounted spindle 20, on which a spindle nut 22 that is open on one side is mounted. The spindle nut 22 therefore forms a pot-shaped brake piston 24, which comprises a piston base 26 and a circumferential wall 28 (see FIG. 4) and is used to apply a brake pad 30 to the brake rotor.

An axial displacement of the brake piston 24 from a retracted position into an extended position and vice versa is effected by a rotation of the spindle 20. In practical terms, an external thread 32 is formed on the circumferential surface of the spindle 20 and an internal thread 34 is formed on the inside on the circumferential wall 28 of the brake piston 24, so that at least one threaded track is formed by the external thread 32 and the internal thread 34 of the brake piston 24. A large number of balls 36 are guided in the threaded track, so that a rotation of the spindle 20 effects an axial displacement of the brake piston 24 along a central axis of rotation of the ball-screw drive 18.

The external thread 32 and the internal thread 34 can also be multi-turn threads, so that a plurality of threaded tracks, in which a large number of balls 36 are guided, are formed by the external thread 32 and the thread 34.

In order to permit the axial movement of the brake piston 24 along the spindle 20, the brake piston 24 is guided in the electromechanical brake 12 so as to be fixed against rotation, for example by means of a key. To drive the spindle 20, the latter has a drive geometry 38. Via the drive geometry 38, the spindle 20 is coupled via a gear mechanism 40 to an electric motor, not visible in FIG. 1. Alternatively, the spindle 20 can also be coupled directly to the electric motor via the drive geometry 38.

As can be seen in FIG. 2, the drive geometry 38 is a shaft 42 which protrudes axially from the remainder of the spindle 20 and preferably has a toothing 44 in order to be coupled to the gear mechanism 40 or the electric motor.

It can likewise be seen in FIGS. 1 and 2 that the spindle 20 projects with its external thread 32 into the interior of the brake piston 24.

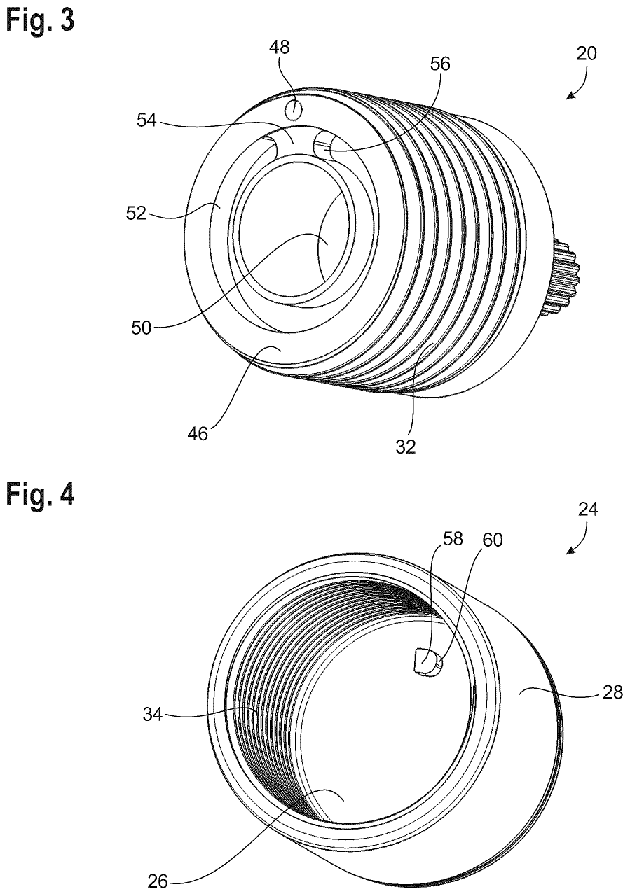

In FIG. 3, it can be seen that the spindle 20 has an end face 46 facing the inside of the piston base 26. Indicated on the end face 46 of the spindle 20 is a return channel 48, which is closed axially, to convey the balls 36. Furthermore, a cavity 50 extending from the end face 46 in the direction of the drive geometry 38 is provided. The cavity 50 is preferably cylindrical and is used to reduce the weight of the ball-screw drive.

It can additionally be seen in FIG. 3 that a groove 52 that is of annular segment shape and extends concentrically with a central axis of rotation of the ball-screw drive 18 is provided in the end face 46. The groove 52 ends circumferentially in a stop wall 54, which thus terminates the groove 52 circumferentially. The stop wall 54 merges smoothly into the remainder of the end face 46, so that the axial length of the spindle 20 is not lengthened despite the provision of the stop wall 54.

As can likewise be seen in FIG. 3, the groove 52 of annular segment shape is at a distance from the circumference of the end face 46. Thus, the groove 52 is formed only in the end face 46 of the spindle 20. In addition, the groove 52 extends through at least 120°. The stop wall 54 formed in the groove 52 has a stop surface 56, which preferably has the form of a cylindrical circular-segment surface.

In FIG. 4, the brake piston 24 is shown in detail, having a stop attachment 58 that is complementary to the stop wall 54 of the spindle 20. It can be seen that the stop attachment 58 projects from the piston base 26 in the direction of the end face 46. The stop extension 58 is placed such that it can penetrate the groove 52 in order to stop the axial movement of the brake piston 24 and also the rotational movement of the spindle 20. The stop attachment 58 is at a distance from the central axis of rotation which corresponds to the distance of the groove 52 from the central axis of rotation. The surface of the stop attachment 58 that comes into contact with the stop wall 54 is a mating surface 60 which is complementary to the stop surface 56 and by means of which, at the end of the axial movement of the brake piston 24 in the direction of the spindle 20, a form fit is produced between the stop wall 54 and the stop attachment 58.

When the electromechanical brake 12 and thus the brake actuator 10 are actuated, then the spindle 20 is driven electrically via the drive geometry 38 and a rotational movement of the spindle 20 occurs. As a result of the rotational movement of the spindle 20 about the central axis of rotation of the ball-screw drive 18, the balls 36 roll along the threaded track defined by the external thread 32 and the internal thread 34 and move towards the piston base 26. There, they are picked up by the return channel 48, guided towards the rear spindle end and inserted into the threaded track again.

Since the brake piston 24 is mounted in the brake calliper 14 so as to be fixed against rotation, an axial movement of the brake piston 24 along the spindle 20 in the direction towards the brake pad 30 occurs. When the brake piston 24 comes into contact with the brake pad 30, the brake piston 24 exerts a force on the latter, so that the brake pad 30 moves in the direction of the brake rotor and the brake 12 is actuated. When the electromechanical brake 12 is released, the spindle 20 is driven in the opposite direction, so that the brake piston 24 completes an axial movement relative to the spindle 20.

At the end of this axial movement, the stop attachment 58 of the brake piston 24 penetrates the groove 52 on the end face 46 of the spindle 20. As a result, a form fit is made between the stop attachment 58 and the stop wall 54 in the groove 52, so that the movement of the spindle 20 is stopped. The brake piston 24 is stopped in such a way that axial play between the brake piston 24 and spindle 20, i.e. between the end face 46 and the piston base 26, continues to be ensured and wedging of the ball-screw drive 18 is prevented.

It is not shown in the figures that, according to a further embodiment of the ball-screw drive 18, at least two grooves 52 of annular segment shape and/or at least two stop attachments 58 can be provided. The stop attachments 58 are arranged such that they can each penetrate only the groove 52 provided.

Depending on the configuration of the ball-screw drive 18, the stop attachments 58 and thus also the grooves 52 can be offset radially relative to one another or, alternatively, adjoin one another in the circumferential direction, so that they are separated circumferentially from one another by the stop walls 54. By means of providing a plurality of stop attachments 58 and grooves 52, a more uniform distribution of force can be achieved and an additional safeguard can be provided.

According to an alternative embodiment, which is likewise not shown in the figures, the groove 52 of annular segment shape extending concentrically with the central axis of rotation of the ball-screw drive 18 is provided in the piston base 26, so that the stop wall 54 is also provided in the piston base 26 and merges smoothly into the latter. Accordingly, the spindle 20 in this embodiment has at least one stop attachment 58 which projects towards the piston base 26 and can engage in the groove 52 in the piston base 26.

Alternatively, the ball-screw drive can also be designed as a normal threaded drive without balls but with threads sliding on one another.

1. Threaded drive (18) for an electromechanical brake (12), having a pot-shaped spindle nut (22) with a base and a circumferential wall (28) which has an internal thread (34) on the inside, a spindle (20) having an external thread (32), which projects with its external thread (32) into the interior of the spindle nut (22), and a drive geometry (38) on the spindle (20) for transmitting a rotational movement to the spindle (20), which, via the external thread (32), moves the spindle nut (22) axially, wherein the spindle (20) has an end face (46) facing an inner side of the base of the spindle nut (22), wherein
either the end face (46) has at least one groove (52) in the shape of an annular segment which extends concentrically with a central axis of rotation of the threaded drive (18) and circumferentially ends in a stop wall (54) terminating the groove (52), and the base of the spindle nut (22) has at least one stop attachment (58) which projects towards the end face (46) and, at the end of the axial movement of the spindle nut (22) relative to the spindle (20), penetrates the groove (52) and strikes the stop wall (54) and stops the movement of the spindle (20) or,
conversely, the base of the spindle nut (22) has at least one groove in the shape of an annular segment which extends concentrically with a central axis of rotation of the threaded drive (18) and circumferentially ends in a stop wall (54) terminating the groove, and the end face (46) of the spindle (20) has at least one stop attachment which projects towards the bottom of the spindle nut (22) and, at the end of the axial movement of the spindle nut (22) relative to the spindle (20), penetrates the groove and strikes the stop wall and stops the movement of the spindle (20).

2. Threaded drive (18) according to claim 1, wherein the spindle nut (22) is a pot-shaped brake piston (24) having a piston base (26).

3. Threaded drive (18) according to claim 1, wherein the drive geometry (38) is present on a shaft (42) protruding axially from the remainder of the spindle (20).

4. Threaded drive (18) according to claim 1, wherein at least two grooves in the shape of an annular segment and/or at least two stop attachments are provided, wherein each stop attachment (58) is arranged such that it can penetrate only its own groove (52).

5. Threaded drive (18) according to claim 4, wherein the at least two stop attachments are offset radially relative to one another.

6. Threaded drive (18) according to claim 4, wherein the at least two stop attachments adjoin one another in the circumferential direction and are separated circumferentially from one another by stop walls.

7. Threaded drive (18) according to claim 1, wherein the at least one groove (52) in the shape of an annular segment is at a distance from the circumference of the end face (46) or the circumferential wall (28).

8. Threaded drive (18) according to claim 1, wherein the spindle (20) has a cavity (50) starting from the end face (46), in particular a cylindrical cavity (50).

9. Threaded drive (18) according to claim 1, wherein the groove (52) in the shape of an annular segment extends through at least 120°.

10. Threaded drive (18) according to claim 1, wherein the stop wall (54) merges smoothly into the remainder of the base of the spindle nut (22) or the end face (46).

11. Threaded drive (18) according to claim 1, wherein the stop wall (54) has a stop surface (56) in the form of a cylindrical circular-segment surface, and the stop attachment (58) has a complementary mating surface (60).

12. Threaded drive (18) according to claim 1, wherein the threaded drive (18) is a ball-screw drive.

13. Brake actuator (10) of an electromechanical brake (12), which has a brake calliper (14) in which an intermediate space (16) for a brake rotor is formed, and, in the intermediate space (16), has a brake pad (30) which can be applied to the brake rotor, a threaded drive (18) according to claim 1, an electric motor, which is coupled in drive terms to the drive geometry (38) of the spindle (20) in order to transmit a rotational movement to the spindle (20), so that the brake piston (24) can be moved by the rotational movement of the spindle (20) between a retracted and an extended position along the central axis of rotation.

14. Electromechanical brake (12), having a brake calliper (14) in which an intermediate space (16) for a brake rotor is formed and, in the intermediate space (16), has a brake pad (30) which can be applied to the brake rotor, and a brake actuator (10) according to claim 13 for moving the brake pad (30) and actuating the brake (12).
